(19) United States
(12) Patent Application Publication
(10) Pub. No.: US 2014/0195894 A1
(43) Pub. Date: Jul. 10, 2014

(54) METHOD AND SYSTEM FOR CONTINUOUS RENDERING OF WEB CONTENT

(71) Applicant: MOBILEMOTION TECHNOLOGIES PRIVATE LIMITED, Bangalore (IN)

(72) Inventor: Bhashkar SHARMA, Bangalore (IN)

(73) Assignee: MOBILEMOTION TECHNOLOGIES PRIVATE LIMITED, Bangalore (IN)

(21) Appl. No.: 14/148,696

(22) Filed: Jan. 6, 2014

Related U.S. Application Data
(60) Provisional application No. 61/749,895, filed on Jan. 7, 2013.

(51) Int. Cl. G06F 17/22

(52) U.S. Cl. CPC G06F 17/2247
USPC 715/234

(57) ABSTRACT

In embodiments, the present invention provides a method and a system for displaying web content on a mobile device. The method and system includes receiving the web content by the mobile device. The web content is received on a user requesting for the web content. Further, the method and system includes processing the web content. The step of processing the web content includes dividing the received web content into sections. Furthermore, the method and system includes rendering a section of the web content. In addition, the method and system includes displaying the rendered section of the web content on the mobile device of a user.

### FIELD OF THE INVENTION

The present invention relates to rendering of web content and in particular, the present invention relates to client side rendering of web content.

### BACKGROUND

The development of portable computing devices has put programmers under constant pressure of developing applications that can fit various screen sizes. Earlier, even though portable computing devices existed, their number was limited. Hence, most of the content were created to be compatible with computer monitors. With the recent exponential growth of a variety of computing devices, programmers and content writers have lost the liberty of making assumptions about the display size of the devices that will display the created content. The absence of development standards pertaining to the display size and resolution have added to the existing problem. Additionally, portable computing devices often operate on low bandwidth. Further, portable computing devices have a relatively smaller display. Therefore, the conventional method of downloading the entire web page before displaying is not beneficial for the portable computing devices in any way. The problems of adjusting the content to fit the display screen and optimizing the rendering of web page have been addressed in a couple of ways.

A conventional method of addressing the problem relates to a design of a new platform for wireless delivery of content to small devices based on BREW (Binary Runtime Environment for Wireless). This method requires the content providers to agree to provide their content using BREW technologies. Alternately, third party content aggregators continuously modify and repackage existing content information using a format suitable for the content or application. The absence of a standard for modifying the content to suit the portable computing devices inhibits the use of this method.

Another method suggests client-side rendering of web pages. Client-side rendering of web pages, or rendering of web-pages in a web browser tends to provide the user with a seamless browsing experience. Further, client-side rendering allows part of a web page to be displayed while the rest of the web page is fetched and stored in the background. This method is beneficial since the white space gap in between loading of two web pages is almost eliminated. However, this method suffers from the drawback of over utilization of resource. This method continuously uses the web browser's resource to pre-fetch web pages, thereby leaving the portable computing device slow and unavailable for other processes.

In light of the above discussion, there is a need for a method and a system to overcome the above stated problems.

### BRIEF DESCRIPTION OF THE INVENTION

The above-mentioned shortcomings, disadvantages and problems are addressed herein which will be understood by reading and understanding the following specification.

In embodiments, the present invention provides a method and a system for displaying web content on a mobile device. The method and system includes receiving the web content by the mobile device. The web content is received on a user requesting for the web content. Further, the method and system includes processing the web content. The step of processing the web content includes dividing the received web content into sections. Furthermore, the method and system includes rendering a section of the web content. In addition, the method and system includes displaying the rendered section of the web content on the mobile device of the user.

In an embodiment, the method and system includes terminating the rendering process upon rendering of a pre-determined number of sections of the web content. The user is capable of configuring the number of sections to be rendered.

In an embodiment, the method and system includes reinitiating the rendering process as the user browses through the web content.

In an embodiment, the method and system includes processing the web content. Processing the web content includes storing the web content in a memory. Further, processing the web content includes modifying the web content based on display parameters of the mobile device. Furthermore, processing the web content includes storing the modified content in a document object model.

In an embodiment, the method and system includes modifying the web content. The step of modifying includes splitting the web content. Further, the step of modifying includes recombining the web content according to a stored template.

### BRIEF DESRIPTION OF THE DRAWINGS

FIG. 1 illustrates a system for displaying web content on a mobile device, in accordance with various embodiments of the present invention;

FIG. 2 illustrates a flowchart of a method for displaying web content on the mobile device, in accordance with various embodiments of the present invention; and

FIG. 3 illustrates a block diagram of a system for displaying web content on the mobile device, in accordance with various embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

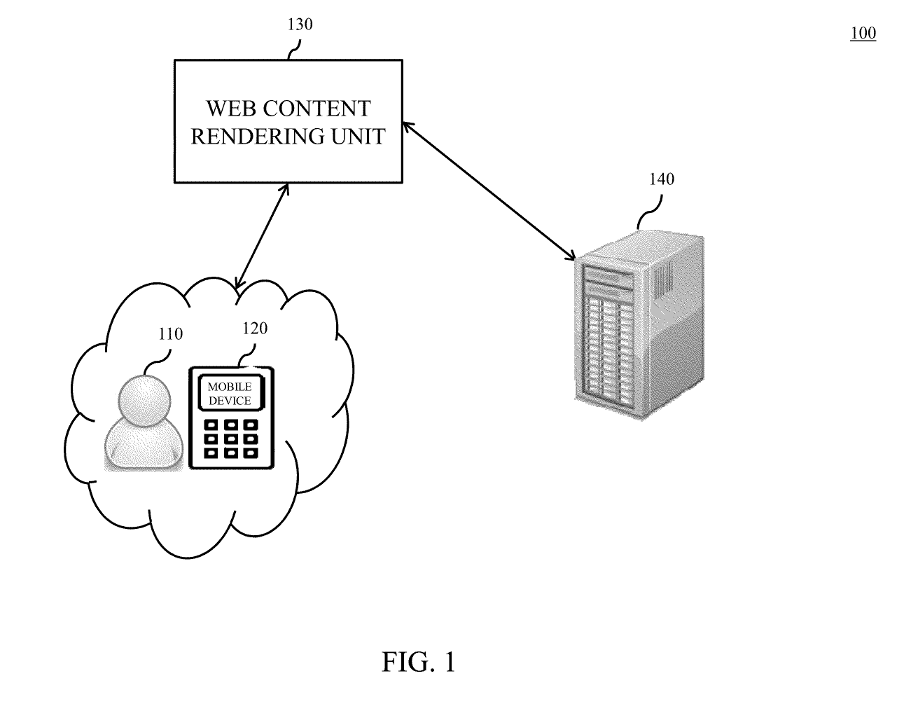

FIG. 1 illustrates a system 100 for displaying web content on a mobile device 120, in accordance with various embodiments of the present invention. The system 100 includes the mobile device 120. The mobile device 120 refers to a handheld electronic device that is used to communicate over a communication network. Examples of the mobile device 120 are a cell phone, a personal digital assistant (PDA), a wireless email terminal, a tablet computer, and the like. Examples of the communication network are a local area network, a wide area network, a wireless network, a telecommunication network, and the like. Types of the telecommunication network include but may not be limited to a global system for mobile communication (GSM) network, a general packet radio service (GPRS) network, a code division multiple access (CDMA) network, enhanced data GSM environment (EDGE), wideband CDMA (WCDMA), and the like.

The mobile device 120 is connected to the Internet via one or more mobile telecommunication technologies. Examples of the mobile telecommunication technologies are second-generation wireless telephone technology (hereinafter 2G), third-generation wireless telephone technology (hereinafter 3G), fourth-generation wireless telephone technology (hereinafter 4G), Wi-Fi, and the like. The Internet, also known as a network of networks, is a global system including a plurality of interconnected networks. The Internet links a large number of public, private, and government networks to make information available within one network available to the rest of the networks. Each network is formed by interconnection of one or more servers.

As in known in the art, a server is a system including hardware and a suitable software. The server is loaded with information that is intended to be shared. Generally, servers operate within client-server architecture. In the client-server architecture, computer programs running on dedicated hardware constitute the server. The server receives requests from other programs called clients. Subsequently, the server responds to the requests by providing the information or service desired by the client. An organization has one or more than one server to cater to the received requests. The one or more servers are connected together. Further, the one or more servers are loaded with information pertaining to the organization which owns, or has rented the one or more servers.

A user 110 uses the mobile device 120 to fetch the required information from the one or more servers using the Internet. In an embodiment, the one or more servers is a book, the user 110 is a reader of the book, and the mobile device 120 is a magnifying glass. The reader uses the magnifying glass to read the book to understand the contents printed in the book.

In another embodiment, the one or more servers is a server of a financial organization, the user 110 is a customer, and the mobile device 120 is an automated teller machine. The customer uses the automated teller machine to retrieve information regarding the customer's account from the server.

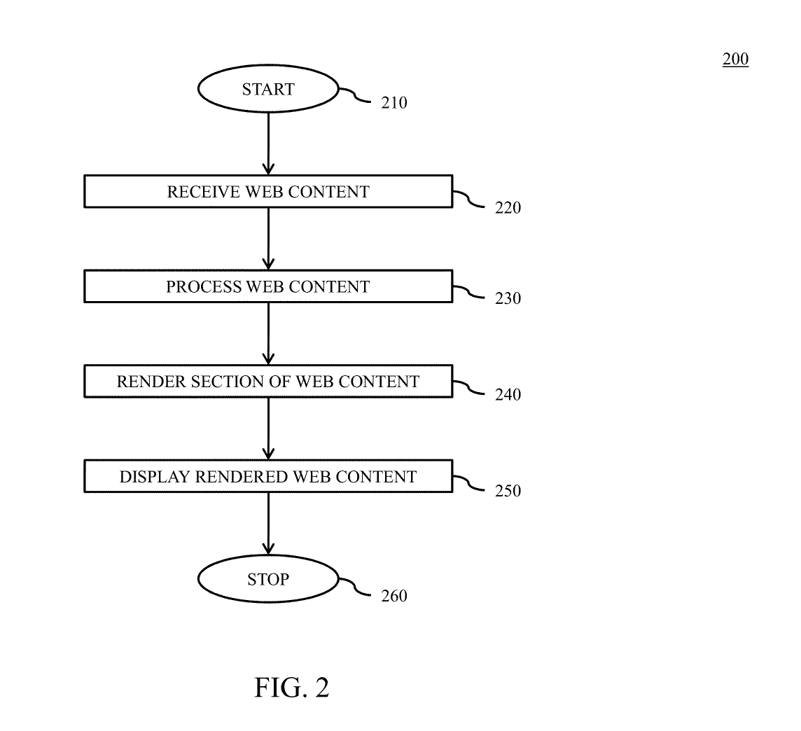

FIG. 2 illustrates a flowchart 200 of a method for displaying web content on the mobile device 120 of the user 110, in accordance with various embodiments of the present invention. At step 210, the flowchart initiates. At step 220, a web content rendering unit 130 present on the mobile device 120 of the user 110 receives the web content from the web server 140. The web content refers to a portion of information present of the web server 140 that the user 110 wishes to access. For example, the web content is a plain text document, an image, a video, and the like. The user 110 instructs the web browser to initiate a request to fetch the web content from the web server 140. The instruction is in the form of a uniform resource locator, a plain text, an image, or a voice command. The web browser connected to the Internet uses the instruction as a reference to fetch the requested web content. Further, the web browser sends the reference to the host server to provide the web content requested for by the user 110. Consequently, the web browser sends the requested web content to mobile device 120 of the web browser. The web content rendering unit 130 integrated with the web browser receives the web content.

At step 230, the web content rendering unit 130 processes the web content. The step for processing the web content includes dividing the received web content into sections. The web content rendering unit 130 receives the entire web content from the web server 140. Further, the web content rendering unit 130 stores the received web content in a memory. Furthermore, the web content rendering unit 130 divides the web content into smaller sections. Each section contains a part of the entire web content. In addition, the web content rendering unit 130 assigns serial numbers to each section. The serial numbers serve as an identity for a particular section until the processing of the particular section is over. Thereafter, the web content rendering unit 130 modifies the web content based on a size of a display of the mobile device 120. This process of modification is known as templating.

The web content rendering unit 130 has a template. The web content rendering unit 130 creates the template based on certain parameters. Examples of the parameters are the size of the display of the mobile device 120, the orientation of the display of the mobile device 120, user 110 preferences, and other available information. Examples of user 110 preferences are word spacing, line spacing, font to be used, and the like.

At step 240, the web content rendering unit 130 renders the web content. In addition to templating the received web content, the web content rendering unit 130 adds a section of the web content to the document object model. Generally, the web content rendering unit 130 adds the sections to Document Object Model (DOM) based on ascending order of the serial number assigned to the particular section. The DOM is an Application Programming Interface (API) for HyperText Markup Language (HTML) and Extensible Markup Language (XML) documents. The DOM defines the logical structure of documents and describes the relation of elements in an HTML page, like input fields, images, paragraphs etc., to the document.

The web content rendering unit 130 sends the processed section to the web browser. Further, the web content rendering unit 130 stops the rendering process. Alternately, the web content rendering unit 130 renders a certain number of sections before terminating the rendering process. The number of sections to be rendered in a go is configurable by the user 110.

In an embodiment, the web content rendering unit 130 does not receive any input from the user 110 on the number of sections to be configured. In this embodiment, the web content rendering unit 130 stops the rendering process after rendering an optimum number of sections. In an embodiment, the wcru stops the rendering process after rendering a number equal to half of the total number of sections into which the web content is divided. In another embodiment, the wcru stops the rendering operation on some other application present on the mobile device 120 requesting the shared hardware. The rendering operation resumes upon the hardware being relieved from the existing operation.

In another embodiment, the wcru uses past history to determine the number of sections to be rendered. For example, the wcru determines from the past history that the user 110 views the first section for most of the documents and subsequently moves on to the next document. Hence, the wcru renders only the first and the second section of the web content. On the user moving to the second section section, the rendering operation reinitiates.

At step 250, the web browser displays the rendered section of the web content on the mobile device 120 of the user 110. Generally, the first section is displayed first. At the same time, the second section is present in the DOM. The web browser displays the second section upon receiving a command from the user 110 to display the second section. As the user 110 progresses through the web content, the user 110 reaches a certain threshold. The threshold is determined based on the number of sections rendered. For example, if the number of sections rendered is 10, the threshold is set to 7. Once the user 110 crosses the certain threshold, the web content rendering unit 130 reinitiates the rendering process. The flowchart terminates at step 260.

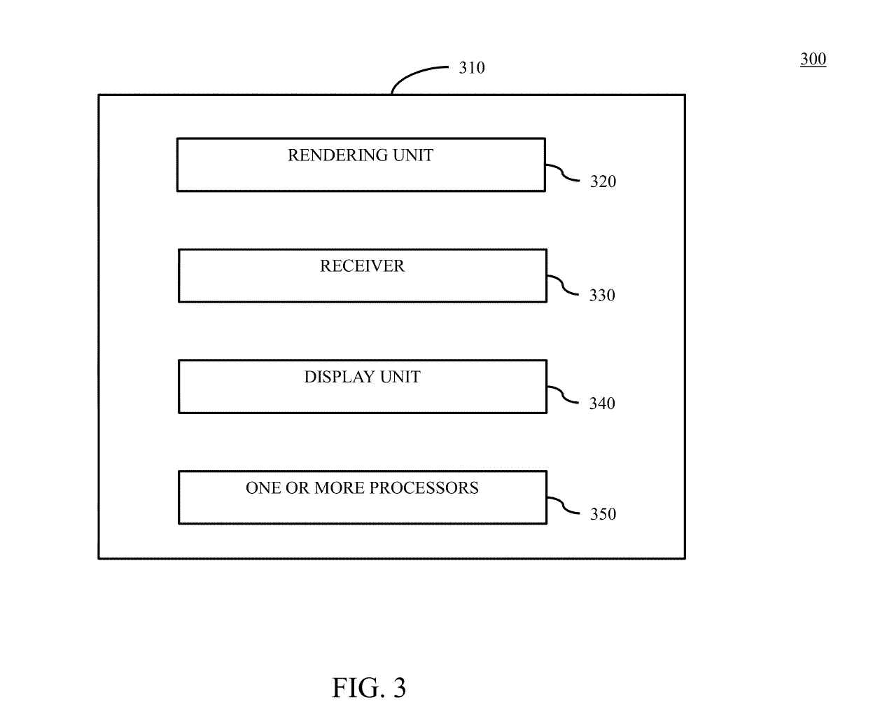

In another aspect of the present invention, FIG. 3 illustrates a block diagram 300 of a system 310 for displaying web content on the mobile device 120, in accordance with various embodiments of the present invention. The system 310 includes a rendering unit 320. The rendering unit is configured to render the web content for a pre-defined number of sections. As explained above, the web content is divided into a plurality of sections. Further, each section is marked with a serial number. The serial number serves as an identity for a particular section.

In addition, the system 310 includes a receiver 330. The receiver 330 is configured to receive the web content from the web server 140. As explained above, the web server 140 sends the web content to the receiver on the user 110 requesting for the web content. The user 110 can request for the web content in various forms, examples of which are given above.

Additionally, the system 310 includes a display unit 340. The display unit 340 displays the rendered content on the mobile device 120. The display unit 340 has a fixed area and a fixed fixed dimension. The web content rendering unit 130 interacts with the display unit to determine the size of the template.

Moreover, the system 310 includes one or more processors 350. The one or more processors 350 process the web content received from the web server 140. The web one or more processors 350 divide the web content into a plurality of sections. Each section is modified as a template. Further, each section is rendered and added to the document object model.

The present invention makes viewing content on portable communication devices seamless. The present invention modifies the content received from the web server 140 to suit the display size of the mobile device 120. In addition, the present invention relieves the resources of the mobile device 120 since the rendering takes place as the user 110 views the content.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for displaying web content on a mobile device associated with a user, the method comprising:
a. receiving the web content by the mobile device, wherein the web content is received upon user requesting for the web content;
b. processing the web content, wherein processing the web content comprises dividing the received web content into a plurality of sections;
c. rendering at least a section of the web content; and
d. displaying the rendered section of the web content on the mobile device of the user.
e.

2. The method as claimed in claim 1, the method comprising terminating the rendering process upon rendering of a pre-determined number of sections of the web content.

3. The method as claimed in claim 1, wherein the number of sections of the web content to be rendered is configurable by the user.

4. The method as claimed in claim 1, comprising reinitiating the rendering process as the user browses through the web content.

5. The method as claimed in claim 1, wherein processing the web content further comprises:
a. storing the web content in a memory;
b. modifying the web content based on display size of the mobile device; and
c. storing the modified content in a document object model.

6. The method as claimed in claim 5, wherein modifying the web content comprises:
a. splitting the web content; and
b. recombining the web content according to a stored template.

7. A system for displaying web content on a mobile device, the system comprising:
a. a receiver configured to receive the web content, wherein the web content is received on a user requesting for the web content;
b. one or more processors configured to process the web content;
c. a rendering unit configured to render the web content for a pre-defined number of sections, wherein the rendering unit comprises a memory unit to store the web content; and
d. a display unit configured to display the rendered web content on the mobile device.

8. The system as claimed in claim 7, wherein the rendering unit scans dimensions of display of the mobile device and navigation system available on the mobile device to determine a suitable layout for the rendered web content.

9. The system as claimed in claim 7, wherein the rendering unit manipulates web content to suit the display including one or more of blank space reduction, blank space insertion, text condensing, margin adjustment, and tab stop adjustment.

10. The system as claimed in claim 7, the system further comprising a memory unit.
